(19) United States
(12) Patent Application Publication
(10) Pub. No.: US 2017/0161803 A1
(43) Pub. Date: Jun. 8, 2017

(54) Smart-Grid Having PLC Networked Sensors

(71) Applicant: Asoka USA Corporation, San Ramon, CA (US)

(72) Inventors: Mingyao XIA, Shenzhen (CN); Eric GRUBEL, Thousand Oaks, CA (US); Dan CASTELLANO, Cupertino, CA (US)

(21) Appl. No.: 15/360,911

(22) Filed: Nov. 23, 2016

Related U.S. Application Data
(63) Continuation of application No. 13/249,058, filed on Sep. 29, 2011, now abandoned.
Application No. 13/249,058 is a continuation-in-part of application No. 13/197,623, filed on Aug. 3, 2011, now Pat. No. 8,644,166.
Application No. 13/197,623 is a continuation-in-part of application No. 13/153,194, filed on Jun. 3, 2011, now Pat. No. 8,364,326.
Application No. 13/153,194 is a continuation-in-part of application No. 13/032,454, filed on Feb. 22, 2011, now Pat. No. 8,755,946.

(51) Int. Cl. G06Q 30/04; G06Q 50/06; H04L 29/08; H04W 4/00; H04B 3/54

(52) U.S. Cl. CPC G06Q 30/04; H04W 4/008; H04B 3/546; H04L 67/125; G06Q 50/06

(57) ABSTRACT

A smart-grid residential service (SRS) uses connected sensors for integrated service monitoring and control of home appliances via the Internet and an in-home PLC network. Such sensors collect power usage information and include an intelligent master device and any of a communication enabled switch, a ZigBee® enabled switch, and a power control switch, each of which operate over a power line communication (PLC) network. The master collects, compiles, and communicates collected data to the network. The SRS provides infrastructure, i.e. communication, IP-TV, climatic control, etc. monitoring and control, power monitoring and control of connection enabled home appliances, other utility usage monitoring, and security monitoring and control. The SRS also provides billing and collection information for the monitored utilities to utility companies.

### CROSS REFERENCE TO RELATED APPLICATIONS

This application is a continuation of U.S. patent application Ser. No. 13/249,058, filed Sep. 29, 2011, which is a continuation-in-part of U.S. patent application Ser. No. 13/197,623, filed Aug. 3, 2011, which issued as U.S. Pat. No. 8,644,166, which application is a continuation-in-part of U.S. patent application Ser. No. 13/153,194, filed Jun. 3, 2011, which issued as U.S. Pat. No. 8,364,326, which application is a continuation-in-part of U.S. patent application Ser. No. 13/032,454, filed Feb. 22, 2011, which issued as U.S. Pat. No. 8,755,946, each of which is incorporated herein in its entirety by this reference thereto.

### BACKGROUND OF THE INVENTION

Technical Field

The invention relates to the monitoring and control of household appliance. More particularly, the invention relates to a smart-grid having PLC networked sensors.

Description of the Background Art

Communication using power line has been limited, until recently, to a few local area networks (LANs) within homes or offices or, at best, within apartment complexes. Power line communication has also been used in a limited number of applications where other types of communication methods do not provide sufficient security and remote connectivity, such as for power line control applications.

Basic devices for connecting to the power line for communication and power supply have been designed and are used to provide service within LANs. But, due to the availability of more efficient competing technologies, the infrastructure for power line communication (PLC) has never been developed enough to make it a mainstream technology. This can be attributed to various reasons, including the higher cost of available devices, the lack of suitable devices for communication using the PLC technology, etc. The result has been that PLC has not found a path for growth in the standard voice and data communication field catered to by technologies such as xDSL, cell phones, and satellite communications.

### SUMMARY OF THE INVENTION

Because the capability for in-home connectivity is part of the PLC network, with special monitoring sensors it is possible to monitor and control appliances connected to these sensors. An embodiment of the invention provides an application that uses PLC technology to provide a full service capability to the consumer and utilities, thus enabling the process of monitoring, billing for usage, verification of billed usage, and payment for the utilities in the home.

Accordingly, an embodiment of the invention provides an integrated service facility to homes via in-home power line networking, where such networking provides communication and media streaming, remote power monitoring and control, and utility and infrastructure monitoring. Such monitoring and control is accomplished by use of sensor devices that connect appliances to the power line network, and the provide the capability to communicate to a local server configured with required software and having appropriate storage capability. The server is also configured to facilitate billing and payment for power and other utility usage.

### BRIEF DESCRIPTION OF THE DRAWINGS

FIG. 1 is a block schematic diagram showing a power switch (SW) device;

FIG. 2 is a block schematic diagram showing a data communication (Ethernet) enabled switch (ETH) device;

FIG. 3 is a block schematic diagram showing a ZigBee® enabled switch (Z-SW) device;

FIG. 4 is a block schematic diagram showing a master (MST) device;

FIG. 5 is a block schematic diagram showing a typical smart-grid residential service system according to the invention;

FIG. 6 is a block schematic diagram showing a an in-home connection for sensor devices that monitor power and utility usage and communication;

FIG. 7 is a block schematic diagram showing a detail of an administration control and communication module of an SRS server according to the invention;

FIG. 8 is a block schematic diagram showing a detail of control software of the SRS server according to the invention;

FIG. 9 is a block schematic diagram showing the format of information storage in a database of the SRS server according to the invention; and

FIG. 10 is a flowchart showing the use of consolidated utility usage data for billing by the utilities for payment by the consumer for usage over a specific period of time according to the invention.

### DETAILED DESCRIPTION OF THE INVENTION

A smart-grid residential service (SRS) uses connected sensors for integrated service monitoring and control of home appliances via the Internet and an in-home PLC network. Such sensors collect power usage information and include an intelligent master device and any of a communication enabled switch, a ZigBee® enabled switch, and a power control switch, each of which operate over a power line communication (PLC) network. The master collects, compiles, and communicates collected data to the network. The SRS provides infrastructure, i.e. communication, IP-TV, climatic control, etc. monitoring and control, power monitoring and control of connection enabled home appliances, other utility usage monitoring, and security monitoring and control. The SRS also provides billing and collection information for the monitored utilities to utility companies.

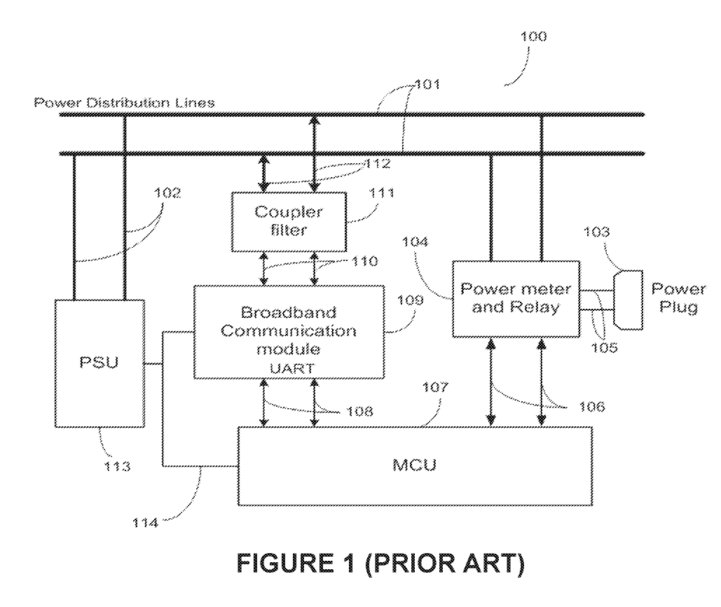

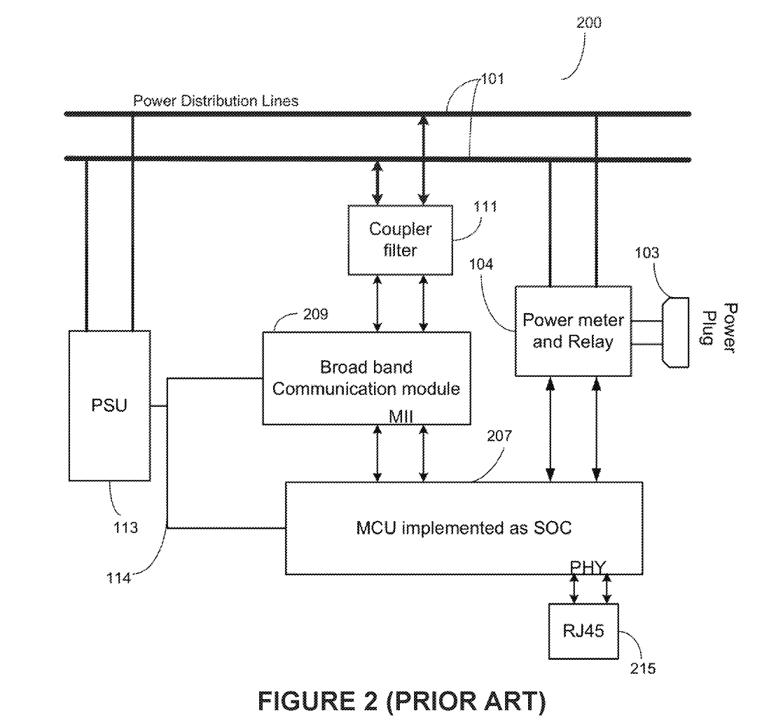

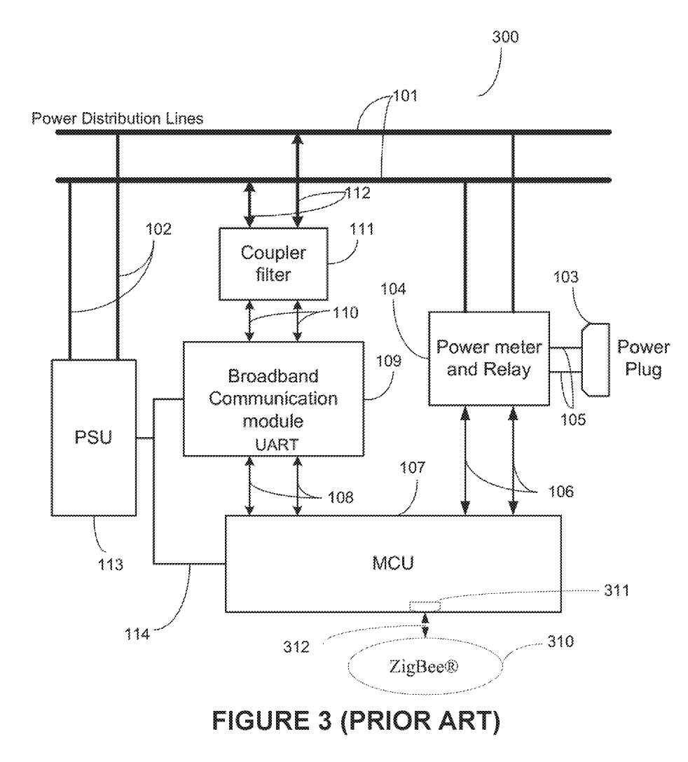

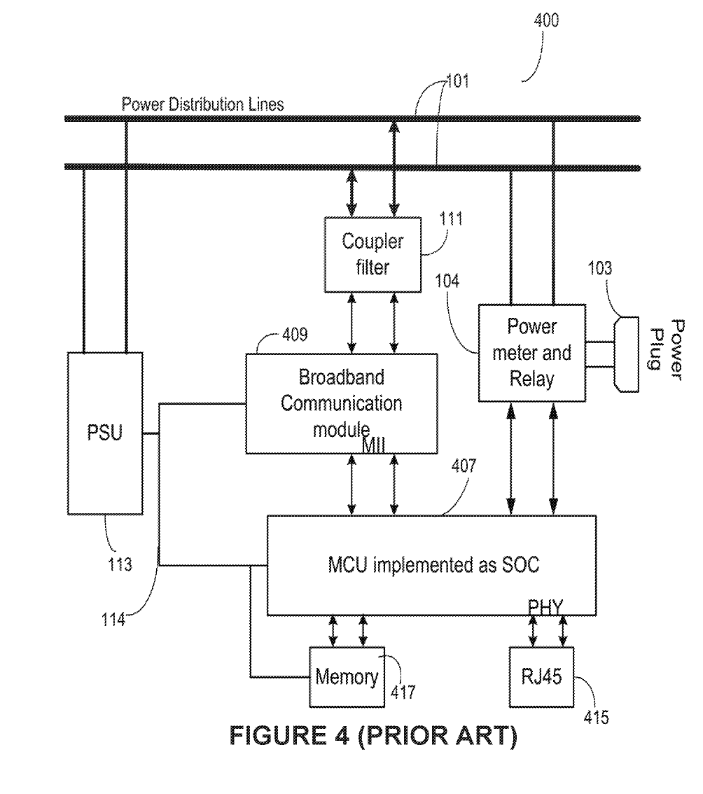

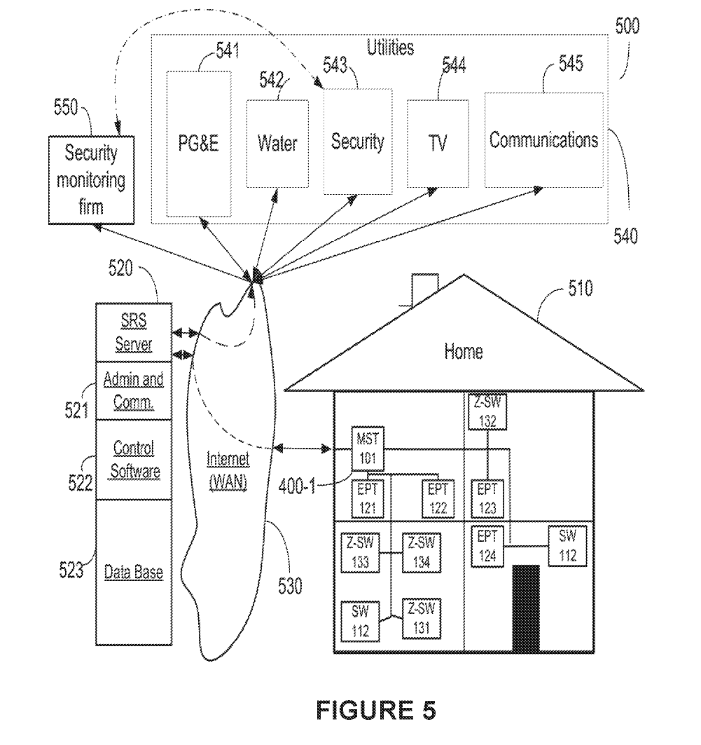

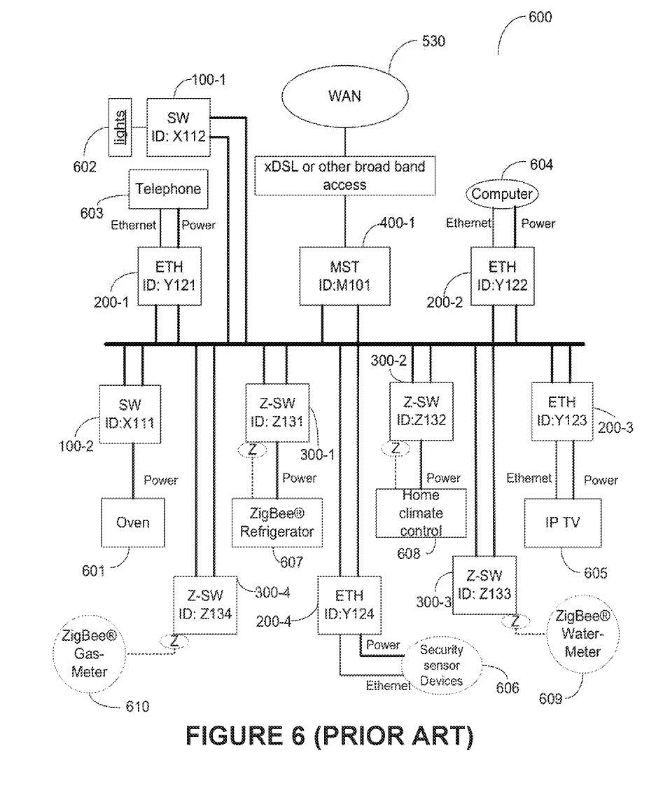

FIG. 5 is a block schematic diagram showing the SRS system 500 according to the invention. The home 510 is enabled with a power line communication (PLC) network having sensor units that provides a connection to enable power monitoring and control capability with various appliances. The sensors used typically are a master (MST) 400 device shown in FIG. 4 and one or more selected from the group of: power control switch (SW) 100 devices shown in FIG. 1, ZigBee® enabled switch (Z-SW) 300 devices shown in FIG. 3, and communication (Ethernet) enabled switch (ETH) 200 devices shown in FIG. 2, all connecting to the in-home PLC network 600 shown in FIG. 6. A brief details of the sensor units used and their operation is provided below.

The Power Control Switch Device (SW)

The SW 100 allows an appliance in the home or office to be connected to the power supply through a power plug on the device. The device provides for the monitoring of power consumption with capability for remote control of the power supply to the connected appliance via the Internet and the PLC network. FIG. 1 is a block schematic diagram showing the SW 100. The SW 100 has a power plug that is connected to the AC power distribution lines 101 through a power meter and relay 104. The relay in the power meter and relay module 104 provides the capability to switch on or switch off the supply to the power plug 103 remotely. It also allows for controlling the power supplied to the plug, where a power control module is included in the power meter and relay module 104. The power meter in the power meter and relay module 104 monitors the power usage by the appliances connected to the power plug. The power meter and relay module 104 is connected via bi-directional communication links 106 to a microcontroller (MCU) 107 similar to an Intel® 8051. The microcontroller accepts the information on the power usage and compiles it prior to transfer to the broadband communication module 109. The power meter in the power meter and relay module 104 continuously monitor the flow of power to the power plug 103 and feed the information to the MCU 107 through the communication links 106. The power usage information is compiled by the MCU 107 and sent to a broadband communication module 109 via communication links 108 connected to a UART enabled port on the communication module 109 for onward transmission over the PLC network.

The Data Communication (Ethernet) Enabled Switch Device (ETH)

The ETH 200 allows an appliance in the home or office to be connected to the power supply through the ETH 200 and provides for the monitoring of power consumption with capability for remote control of the connected appliance. The ETH 200 also provides the capability for broadband PLC-based data communication, where the data and communication devices are connected to the power distribution line through a communication port, typically an Ethernet port on the ETH 200. Multiple ETH 200 units can be used to establish a PLC based local area network (LAN) for communication.

FIG. 2 is a block schematic diagram showing the ETH 200. The ETH 200 is a combination of two sub-units: a broadband PLC sub-unit, and a SW sub-unit similar to SW 100. The SW sub-unit in this instantiation (ETH 200) uses broadband communication for information transfer on power usage and remote control of connected appliances over an Internet connection. The broadband PLC Ethernet bridge adaptor module includes a 200 Mbps communication sub-unit for broadband sharing including, for example, on line gaming, voice over Internet protocol (VOIP), Internet protocol television (IPTV), and for audio and video streaming.

In FIG. 2, the communication subunit comprises an RJ45 connector 215 for establishing a connection to the subunit through a built-in PHY on an MCU 207. The power monitoring and control information of the associated power plug 103 is collected by the power meter and relay unit 104 and sent to the MCU 207. The information is cached and processed by the MCU 207 and then passed to the broadband communication module 209 through a media independent Interface (MII) port on the communication module 209. The communication module 209, in this case, is common for communication and for power usage and status information transfer and control. Here, the communication module 209 is used to convert the incoming data stream into the broadband format used for PLC. The switch sub-unit of the ETH 200 operates similar to the SW 100. The power usage and power plug status information collected by the power meter and relay module 104 are also passed through the MCU 207 to the broadband communication module 209 for conversion to an output information stream using the broadband PLC format. Both the data stream and the power usage and status information stream are then transferred from the communication module 209 to the power distribution lines 101 in the home or office through the coupler filter module 111. Similarly, the communication module 209 receives the incoming communication data streams and the command and control instructions that are sent to the ETH 200 and passes them to the respective modules of the ETH 200 for processing.

The broadband communication module 209 is also enabled with a unique address so that communication to it and from it can be identified. Because the broadband communication elements are bidirectional, the broadband communication module can send and receive full duplex broadband communication between itself and any communication device connected to the RJ45 connector 215 via the MCU 207. Similarly, the communication module 209 can send out information streams comprising the power usage and status of the plug to the AC power distribution lines 101, and receive command and control information streams from the AC power distribution lines 101. The received data and command and control information streams are decoded, the address is checked to see if it correct, and the streams are decrypted, if needed, based on the address. The communication module 209 then converts the received data stream into an analog format and sends it through the MII interface of the MCU for transfer through the PHY to the RJ45 module 215, and thence to the connected customer device. Similarly, the communication module sends the command and control information to the MCU 207 for interpretation. The MCU 207 then generates instructions to the power meter and relay module 104 that are used by the power meter and relay module 104 to control the power flow to the power plug 103, and thence to the appliance connected to the power plug 103.

The use of multiple ETH 200 devices within a home or office enables PLC local area network connectivity within the home or office. Here, the disclosed use of broadband communication within the PLC LAN, using the ETH devices, enables streaming media delivery capability and IPTV delivery capability for connected display devices, connected to appropriate communication units within the PLC LAN.

The ZigBee® Enabled Switch Device (Z-SW)

FIG. 3 is a block schematic diagram showing the Z-SW 300 device having an integrated ZigBee® unit 310. This allows an appliance in the home or office to be connected to the power supply and power line communication link through the Z-SW 300 which incorporates the ZigBee® device 310. The Z-SW 300 provides for the monitoring of power consumption with capability for remote control of the power flow to the connected appliance via the Internet. The ZigBee® unit 310 provides for additional operational control and monitoring through the wireless connection to ZigBee® technology enabled appliances.

The Z-SW 300 has a power plug 103 that is connected to the AC power distribution lines 101 through a power meter and relay 104. The relay in the power meter and relay module 104 provides the capability to switch on or switch off the supply to the power plug 103 remotely. It also allows for controlling the power supplied to the plug when a power control module is included in the power meter and relay module 104. The power meter in the power meter and relay module 104 monitors the power usage by the appliances connected to the power plug. The power meter and relay module 104 is connected via bi-directional communication links 106 to a microcontroller (MCU) 107. The MCU 107 accepts the information on the power usage from the power meter and relay module 104 and compiles this information prior to transfer to the broadband communication module 109. The power meter in the power meter and relay module 104 continuously monitors the flow of power to the power plug 103 and feeds the information to the MCU 107 through the communication links 106. The power usage information is compiled by the MCU 107 and sent to a broadband communication module 109 via communication links 108 connected to a UART enabled port on the communication module 109, thus enabling the compiled data to be transmitted out.

The operational commands for the ZigBee® unit 310 of the Z-SW 300 are received over the power line at the broadband communication module 109 as a data stream. These commands are demodulated, decrypted, and provided to the MCU 107 over the communication links 109 via the UART enabled port. The MCU 107 converts the data into instructions and passes them on to the ZigBee® unit 310 via the bidirectional port 311 over the link 312. The ZigBee® unit 310 sends out commands to the ZigBee® technology enabled appliance connected to the Z-SW 300, based on received instructions, to execute operational commands of reading meters, changing temperature settings, etc. The response after the command has been executed is sent back to the built-in ZigBee® unit 310 by the ZigBee® technology enabled appliance, which then transfers it to information and passes it on to the MCU 107 via the bidirectional link 312 through the port 311. The MCU collects the information and forwards it with the address to be responded to by the broadband communication module 109 via communication links 108 connected to the UART enabled port on the communication module 109.

In the example of FIG. 3, the communication module 109 modulates the received information to a communication data stream for transmission over a broadband communication frequency band that is typically used for power line communication (PLC) over the AC power distribution lines within a local area network (LAN). The typical broadband used for PLC communication band in the 2 to 30 MHz range, providing up to a 200 Mbps data rate. The communication module 109 sends out the modulated the data stream over the broadband connection 110 to a coupler filter 111 which is connected to the AC power distribution lines 101 by power line connections 112. The coupler filter acts as a bi-directional high pass filter to filter out power line frequency interference from the communication module. The broadband communication module 109 also demodulates the communication stream received over the AC power distribution lines 101 to provide the command and control instructions for power control and operational control to the MCU 107. The MCU 107 interprets any received command and control instructions to the power meter and instructs the power meter and relay module 104 for controlling the power flow to the power plug 103. The MCU 107 also interprets any operational command and instructions for the ZigBee® unit 310 and passes on these to the ZigBee® unit 310 to be directed tom the ZigBee® technology enabled connected appliances.

The Master Device (MST)

The MST 400 provides the computing power and storage capability necessary to collect and compile power consumption information provided to it. The MST enables the collected data to be transmitted to a wide area network for group compilation. The connected SW 100, ETH 200, and Z-SW 300 devices within the home or office monitor the power usage of devices and appliances connected to their respective power plugs. This information is sent over the local power distribution lines in the home or office to the MST 400 for compilation of data on usage. With the capability and computing power available and with appropriate software, the MST 400 can exert local and emergency control of the appliances connected to the SW 100, ETH 200, and Z-SW 300 devices. The MST 400 also acts as a gateway connecting to the broadband communication modem to enable a communication pathway to the internet cloud/wide area network (WAN) cloud.

FIG. 4 is a block schematic diagram showing an MST 400. In this implementation, a 32 bit MCU is implemented as a system on chip (SOC) 407. The SOC 407 implementation provides for higher processing power and integration of modules with the MCU. The SOC 407 integrates a PHY into the MCU, allowing the RJ45 connector 415 to connect the customer's modem device directly to a port on the SOC 407. This connection is a 10/100 base TX, auto-negotiation Ethernet port and provides the gateway to the Internet through any connected modem for the PLC communication from all the connected ETH units within the PLC network. The typical communication module of the MST 400 uses, for example, any one chosen modulation scheme from the list of modulation protocols comprising OFDM, QAM1024/256/64/16, DQPSK, DBPSK, and ROBO, for sending and receiving communication data streams to the connected ETH units within the PLC network. The frequency band used for broadband PLC is 2 to 30 MHz, with a data transfer rate of up to 200 Mbps.

The gateway provided by the MST 400 is also used to send out the collected and processed information on the power usage and utility usage, as well as the status of the power monitoring and relay units within the PLC, for enabling control of the power plug 103. Any remote control commands are received from the Web via the gateway provided by the MST 400 for transfer to connected SW 100, ETH 200, and Z-SW 300 units for control of the power flow to connected appliances. In the MST 400, the modulation, frequency band, and data rates are the same as those used for the information and command transfer within the PLC network. The SOC 407 is enabled to enforce all communication related security protocols associated within the PLC network.

All data and power monitoring and control information is sent to the SOC 407 by the connected SW 100, Z-SW 300, and ETH 200 within the home or office via the power distribution lines 101 through the coupler filter module 111 and the communication module 409. The communication module 409 of the MST 400 is used to demodulate the incoming streams and decrypt them prior to transferring them to the MCU that forms part of the SOC 407. The SOC 407 receives the information and processes it, by compiling and consolidating it, for outward transmission to the Web.

The SOC 407 also has a memory 417 associated with it, typically connected to a memory port on the SOC 407. The memory 417 enables the SOC 407 to store the received power monitoring and control information prior to processing and compiling the information. The memory 417 is also used to store the compiled information to transmit it out through the gateway optimally when the bandwidth usage for data communication is low. The memory 417 also stores the transaction history with a timestamp for the data communication and power usage information transmitted out, and for incoming remote commands sent to the connected SW 100 and ETH 400 within the home or office. The memory 417 provides for tracking of performance and remote debugging capability with pinging and path tracking capability for the MST 400, as well as the connected SW 100 and ETH 200.

The MST 400 provides a power plug 103 of its own that is connected to the power distribution lines 101 through a power meter and relay 104 for connecting any needed appliance with the necessary power monitoring and control capability. This monitored information is sent to the MCU, which is implemented as an SOC 407, to be combined with the information received over the PLC LAN over the power distribution lines 101 through the coupler filter module 111 and the communication module 409. This collected information forms part of the power monitoring information input to the MST 400. The power monitoring information is stored in the memory and compiled and processed for transmission to the monitoring sources in the WAN through the modem connected to the SOC 407 port with the RJ45 connector 415. The transfer of the compiled information is typically done as in store and forward manner with storage in the memory 417 to enable best use of the available bandwidth of the gateway, as discussed earlier.

Remote control commands received via the gateway are received through duplex port with the RJ45 connector 415 from the connected modem. These control commands are interpreted by the SOC 407 of the MST 400 and sent to the respective SW 100, ETH 200, or Z-SW 300 to which it is addressed over the broadband PLC network through communication module 409 and coupler filter module 111 for necessary action at the addressed receiving units.

Usage of the Sensors Over the PLC Network

As described above, the individual sensor devices SW 100, ETH 200, Z-SW 300, and MST 400 are used in the appropriate locations to connect and control appliances on the PLC network. The SW devices 100 are used to monitor and control the power that is supplied to connected appliances. The Z-SW 300 devices enable the power monitoring and control of the connected appliances, as with the SW 100 and, in addition, provide remote operational control of a connected ZigBee® technology enabled intelligent appliances. Also, the Z-SW 300 on the PLC network 600 uses ZigBee® technology to connect to intelligent utility meters for gas, water, etc. for monitoring of the utility usage. The ETH 200 is used to provide power monitoring and control capability, as well as communication and streaming media capability for connected communication and TV units within the home. The MST 400 is used to collect the power usage information from the various sensor units connected over the PLC circuit and to store and consolidate the usage information. The MST 400 acts as a gateway to the internet wide area network (WAN) to send and receive data and control information. The received data and communication packets are forwarded to the ETH 200 devices to enable communication and streaming media capabilities of the PLC network.

The detailed operation of the sensor units and the in-home PLC network are described in the patent application Ser. No. 13/197,623, filed Aug. 3, 2011 which, in turn, claims priority to U.S. patent application Ser. No. 13/153,194, filed Jun. 3, 2011 which, in turn, claims priority to U.S. patent application Ser. No. 13/032,454, filed Feb. 22, 2011, each of which claim inventions made by the same inventors and assigned to the same assignee, and each of which are all incorporated herein in its entirety by this reference thereto.

As shown in FIG. 6, the in-home PLC network 600 comprises the various home appliances and meters connected through the sensor devices. The oven 601 and lights 602 are connected to the power line of the in-home PLC network through the SW 100-1 and SW 100-2 that provide monitoring and control of power supply to these appliances. The ETH 200 are used to connect to any communication and streaming media appliances to the PLC network, such that the communication appliances use the PLC network's communication capability to send and receive voice, data, and streaming video. As shown in the exemplary PLC network 600, the ETH 200-1 connects the communication unit 603 to the PLC network 600. The ETH 200-2 is used for connecting the computer 604. Similarly, the IP-TV 605 and the security monitoring units in the home 606 are connected to the PLC network 600 using ETH devices 200-3 and 200-4, respectively. The Z-SW units 300 are used to connect the ZigBee® enabled intelligent appliances to monitor and control the power usage and also use the ZigBee® connection to control the operation of the intelligent appliances. The Z-SW 300-1 is used to connect the ZigBee® enabled refrigerator 607 and the Z-SW 300-2 is used to control the operation of the ZigBee® enabled home climate control 608. The Z-SW 300-3 and 300-4 are both connected to ZigBee® enabled water-meter 609 and ZigBee® enabled gas-meter 610 to facilitate monitoring and reading of the water usage and gas usage of the home.

The SRS System

In FIG. 5, the MST 400-1 collects all the usage information from the home 510 and consolidates this information into a usable format for storage on the MST 400-1. The MST 400-1 then sends the consolidated information to an SRS server 520, shown as the SRS system of FIG. 5, over the WAN 530. The SRS server 520 provides administrative communication and control to the home appliances over the WAN 530 through the MST 400-1 and the PLC network 600 using the built-in administrative communication and control capability 521.

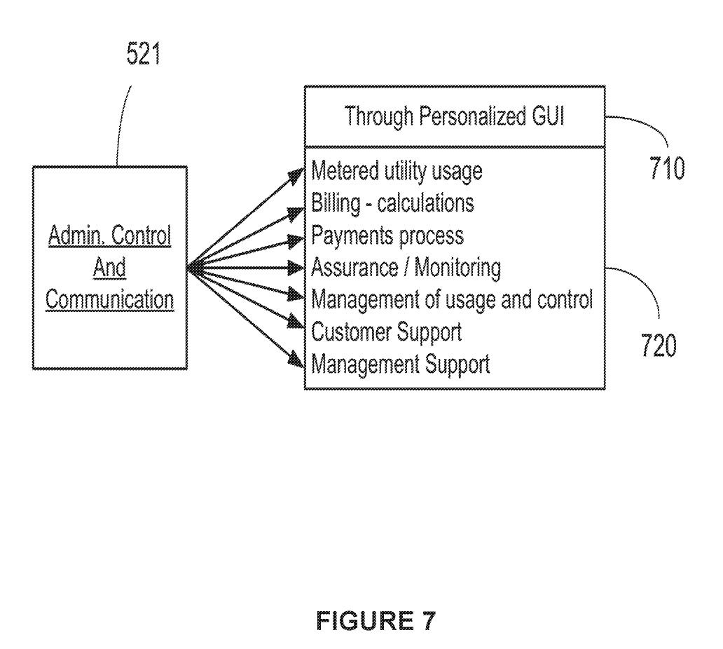

FIG. 7 is a block schematic diagram that shows the administrative capabilities 521 established on the SRS server 520. In this embodiment, all of the administrative capability is provided through a personalized graphical user interface (GUI) 710 that provides the customer access to the data for checking and providing needed operational instructions. The various administrative items 720 that can be addressed or reviewed by the customer using the GUI 710 include, for example, current metered utility usage with individual appliance usage, prior billing and payment information, utility usage trend over time periods, security assurance status, monitoring and control engagement details, monitoring and management of appliances through the system connections, and additional customer support activities and management support activities.

The SRS system 500 also provides the consumer with the capability to monitor and compare current utility usage with past usage data for utilities to optimize and reduce the usage at individual connected appliances. It also provides the consumer with the capability to monitor and control, via remote as well as local control, the individual connected appliances through the WAN and PLC network to reduce usage and eliminate waste. Thus, a significant aspect of the invention is its contribution to ‘green’ technology.

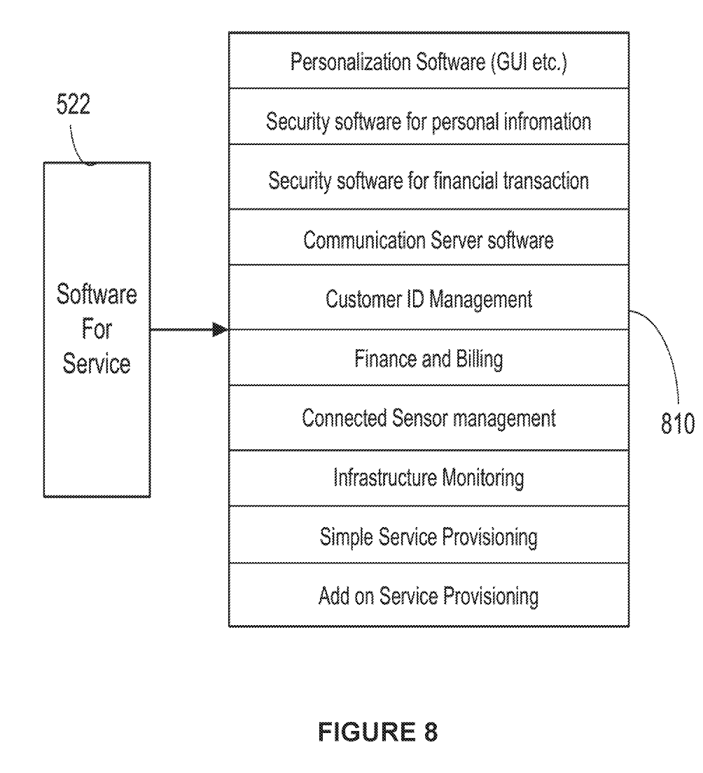

FIG. 8 is a block schematic diagram that shows a group of service software 522 running on the SRS server 520. The software groups 810 allow the system to provide the necessary services to the consumer. The software covers the management functions described previously and also provides security for financial transactions and personal information stored by providing for firewalls, password protection, etc. for the information received and stored in the SRS server 520. In addition, the software provides for encryption, validation, and other communication authentication for any inputs to or outputs from the SRS server 520.

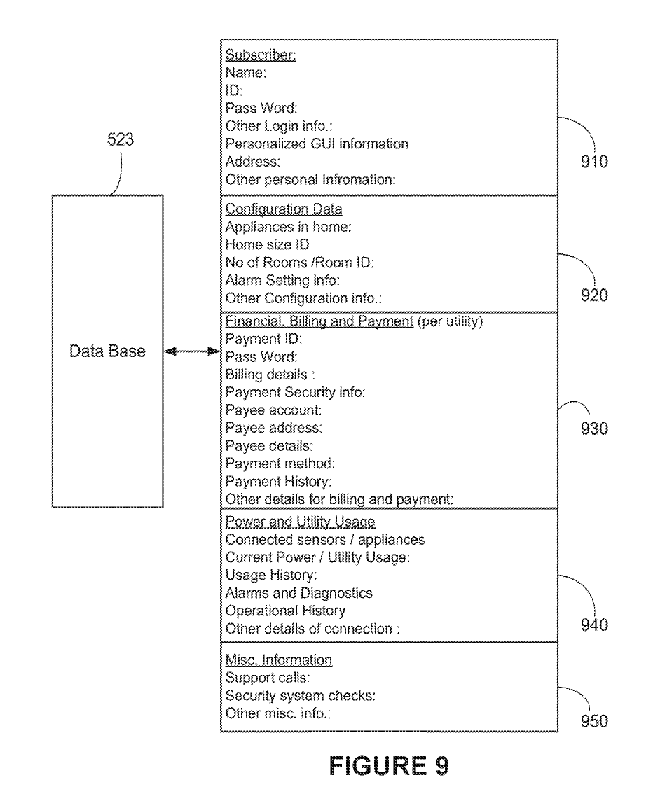

FIG. 9 is a block schematic diagram that shows a sample of the information stored in the database 523 of the SRS server 520. This information includes, but is not limited to, subscriber information 910, including validation and security information; configuration data for the home 920, which includes information on the home size, home alarm setting, and other configuration information, etc.; financial, billing, and payment related information 930, that includes information regarding the billing and payment process information of the customer and the payee; power and utility usage of the home 940 that is provided as a consolidated statement by the MST 400-1, where the information is retained in a format that allows tracing the usage back to individual connected appliances in the home, thus allowing the consumer full capability to monitor and control the usage; and miscellaneous information that supports the customer 950.

Even though the use of the SRS server is shown herein as being connected to one home 510, those skilled in the art will appreciate that the invention is not so limited. The SRS server 520 typically has enough computing power and storage capability to handle a number of connected homes in a local area that form a home group.

Once the information is collected and stored, the SRS server 520 provides the utility usage information to appropriate connected utility center offices 540 of utility companies to check and generate billing for individual homes, such as home 510 in the home group. Typical connected utility companies can include a power and gas utility 541, water supply utility 542, security company 543, TV company 544, and phone and Internet company 545. The bills are sent back to the SRS server 520 by the individual utilities 540, where it can be checked by the consumer against the utility usage using the PLC network 600 and WAN 530 connectivity to the SRS server 520. Once agreement has been reached, the consumer initiates payment to the utility company through the capabilities of the SRS server 520 of the SRS system 500.

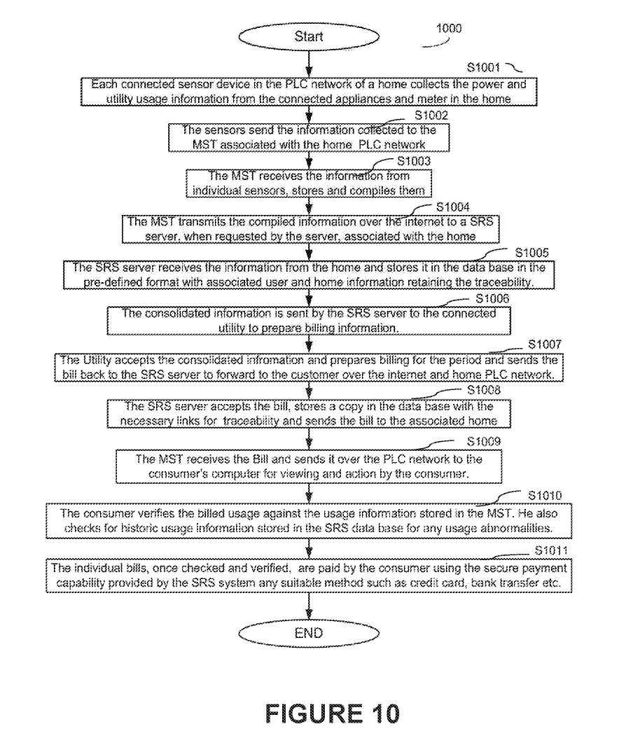

FIG. 10 is a flowchart 1000 of the SRS system 500 showing the operation of billing and payment process for utilities.

Each connected sensor device in the home collects the power usage information and the utility usage information from the connected appliances and meters. For example, the Z-SW 300-3 monitors the water usage using the ZigBee® connection to the ZigBee® enabled water meter 609 (S1001).

The connected sensor devices comprising at least any one of an SW 100, ETH 200, Z-SW 300 send the collected information to the in-home MST 400-1 over the power line of the in-home PLC network 600 for consolidation. In this example, the water usage information from the meter 603 sent by the Z-SW 300-3 is also included with the information sent over the PLC network 600 (S1002).

The MST 400-1 receives the information sent over the PLC network 600 by the individual sensors and stores and consolidates the information where needed, for example the power usage for the home is consolidated (S1003).

The MST 400-1 transmits the individual and consolidated information to the connected SRS server 520 over the Internet when requested by the SRS server 520 (S1004).

The SRS server 520 receives the information from all the homes associated with the SRS server 520. The received information from each home is linked with the home identity and consumer identity and stored in pre-defined format in the database 523 of the SRS server 520 with full traceability to the originating in-home sensor devices. It also consolidates the utility usage information for individual utility center, such as PG&E 541, water utility 542, home security service 543, TV utility 544, communication utility 545, etc. separately and stores the information in the database 523 (S1005).

The consolidated usage information of each utility, for each home, for specified billing periods, as generated by the SRS server 520 is sent to the specific utility center. For example, the consolidated information from home 510 on water usage over a specified billing period is sent to the water utility center 542 for generating a bill for the period. In the same way, the consolidated usage information for power usage and gas usage from home 510 is sent to PG&E for generating a bill for power and gas for the specified period (S1006).

The utility centers 541 to 545 accept the billing information from the home 510 sent to them by the SRS server 520 over the WAN. The bill for the home 510 for a specific utility usage for the period is generated by the individual utility center and sent back to the SRS server 520 for forwarding to the consumer over the communication pathway over the WAN to the MST 400-1 of the home 510 (S1007).

The SRS server receives the bills for the home 510 from the utility centers 541 to 545, stores a copy of each for reference in the data base 523, and sends the bills to the MST 400-1 of home 510 for checking and payment (S1008).

The MST 400-1 receives the bill for the individual utilities and provides it to the consumer over the communication channels of the PLC network 600 for viewing and action (S1009).

The consumer using the communication capability of the ETH 200, e.g. the ETH 200-2 using the Internet connection, checks the bills received against consolidated utility usage information stored in the memory of the MST 400-1 and also checks the prior usage for similar periods of usage stored in the data base 523 of the SRS server 520 (S1010).

Once the checking and verification is done, the consumer pays the individual bills to each of the utilities using the secure bill payment facility, using any approved means of payment available through the SRS system 500. The SRS system is then able to store all the payments made for future verification in the database 523 of the SRS server 520 for future tracking. The approved mode of payment can include any of credit card payment, bank transfer, etc. (S1011).

A person skilled-in-the-art would readily appreciate that the invention disclosed herein is described with respect to specific exemplary embodiments of the devices and systems currently used. It is also possible to provide other formats for presentation of the collected data and information, which may be more in line with the policy maker's needs. However, these described embodiments should not be considered limitations on the scope of the invention. Specifically, other implementations of the disclosed invention are envisioned and hence the invention should not be considered to be limited, to the specific embodiments discussed herein above. The system may be implemented with processing in dedicated central computing facility, in distributed computing facility in the WAN cloud, or a combination of the two. The units, devices, and systems may be implemented as hardware, software implemented and running over hardware such as computers, distributed or otherwise, as assembly of individual components, and/or as a combination of components and integrated circuits or SOCs. The invention should not be considered as being limited in scope based on specific block level details, but should be considered on the basis of current and future envisioned functionality.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. An apparatus, comprising:
a smart-grid residential service (SRS) server configured for communication with a wide area network (WAN);
said SRS server configured for communication with a master switch (MST) device via said WAN, said MST configured for collection of power and utility use information for at least one home from an associated in-home power line communication (PLC) network;
a plurality of connected sensors configured for integrated service monitoring and a control of home appliances via the Internet and an in-home power line communication network (PLC);
said sensors communicating over the PLC, the sensors comprising a two or more of ZigBee® enabled switches, power control switches, or communication enabled switches;
each said sensor independently monitoring power use and said MST collecting the power use;
said SRS server configured to request and receive said power and utility use information from said MST via said WAN;
said SRS server configured for communication with a plurality of individual utilities via said WAN;
said SRS server configured to collect and store said power and utility use information and to send said power and utility use information to said individual utilities to generate a bill in accordance with said power and utility use information for each respective utility for a specified billing period; and
said SRS server configured to collect each bill generated for said power and utility use information from each said respective utility and to forward each said bill to said home for verification of each said bill against power and utility use information from said MST and power and utility use information stored in said SRS server for verification prior to payment of each said bill for each respective utility.

2. The apparatus of claim 1, wherein said MST collects said power and utility use information, at least in part, with at least one ZigBee® connection to a ZigBee® enabled device.

3. The apparatus of claim 1, said SRS server configured to link power and utility use information from each of a plurality of homes with a home and/or consumer identity; and to store said power and utility use information in a pre-defined format in an SRS server database.

4. The apparatus of claim 3, said SRS server configured to provide full traceability to originating in-home sensors for power and utility use information stored in said SRS server database.

5. The apparatus of claim 3, said SRS server configured to consolidate power and utility use information for each respective utility; and to store said power and utility use information separately in said SRS database.

6. The apparatus of claim 5, said SRS server configured to consolidate said power and utility use information for each respective utility, for each home, for specified billing periods, and to send said power and utility use information for each home to each respective utility.

7. The utility apparatus of claim 1, said SRS server configured to check current power and utility use information against prior power and utility use information stored in an SRS database for similar periods of use).

8. (canceled)

9. (canceled)

10. The apparatus of claim 1, said SRS configured to provide an administrative capability via a graphical user interface (GUI), said GUI configured to provide the user access to any of current metered utility usage with individual appliance usage, prior billing and payment information, utility usage trend over time periods, security assurance status, monitoring and control engagement details, monitoring and management of appliances through system connections, and additional customer support activities and management support activities.

11. The apparatus of claim 1, said SRS server configured to allow a user to monitor and compare current power and utility use information with past power and utility use information to optimize and reduce power use by individual connected appliances.

12. The apparatus of claim 1, said SRS server configured to allow a user to monitor and control, via remote and/or local control, individual connected appliances through said WAN and/or said PLC network.

13. The apparatus of claim 1, said SRS server comprising a database configured to store any of subscriber information, including validation and security information; configuration data for a home, including information on home size, home alarm setting, and other configuration information; financial, billing, and payment related information, including information regarding billing and payment process information of a user and a payee; power and utility use of the home, provided as a consolidated statement, where such power and utility use information is retained in a format that allows tracing of use back to individual connected appliances in the home to allow the user full capability to monitor and control the use; and miscellaneous information that supports the user.

14. The apparatus of claim 1, said SRS server configured to support a plurality of homes in a local area that form a home group.

15. The apparatus of claim 1, said utilities comprising any of a power and gas utility, water supply utility, security company, TV company, and phone and Internet company.

16. A method, comprising:
configuring a smart-grid residential service (SRS) server for communication with a wide area network (WAN);
configuring said SRS server for communication with a master switch (MST) device via said WAN, said MST configured for collection of power and utility use information for at least one home from an associated in-home power line communication (PLC) network;
configuring a plurality of connected sensors for integrated service monitoring and a control of home appliances via the Internet and an in-home power line communication network (PLC);
configuring said sensors to communicate over the PLC, the sensors comprising a two or more of ZigBee® enabled switches, power control switches, or communication enabled switches;
configuring each said sensor to independently monitor power use and configuring said MST to collect the power use;
configuring said SRS server to request and receive said power and utility use information from said MST via said WAN;
configuring said SRS server for communication with a plurality of individual utilities via said WAN;
configuring said SRS server to collect and store said power and utility use information and to send said power and utility use information to said individual utilities to generate a bill in accordance with said power and utility use information for each respective utility for a specified billing period; and
configuring said SRS server to collect each bill generated for said power and utility use information from each said respective utility and to forward each said bill to said home for verification of each said bill against power and utility use information from said MST and power and utility use information stored in said SRS server for verification prior to payment of each said bill for each respective utility.

17. An electronic storage medium containing therein program instructions which, when executed by a processor, implement the method of claim 16.
